(19) United States
(12) Patent Application Publication
(10) Pub. No.: US 2007/0204079 A1
(43) Pub. Date: Aug. 30, 2007

(54) Bidirectional convertible KVM switch assembly structure and its KVM switch

(75) Inventor: Hung-June Wu, Taipei City (TW)

Correspondence Address: John G. Chupa;Law Offices of John Chupa & Associates, P.C., Suite 50, 28535 Orchard Lake Road, Farmington Hills, MI, 48334, US

(73) Assignee: JUNE-ON CO., LTD.

(21) Appl. No.: 11/493,880

(22) Filed: Jul. 26, 2006

(30) Foreign Application Priority Data
Feb. 24, 2006 (TW) 095203156

(51) Int. Cl. G06F 13/38; G06F 13/12

(52) U.S. Cl. 710/62

(57) ABSTRACT

The present invention discloses a bidirectional convertible KVM switch assembly structure and its KVM switch, wherein the assembly structure uses a base to contain a KVM switch connected to a rear end of a four-in-one KVM switch and fixes the KVM switch, and the base and the KVM switch are latched with each other by male and female connectors (or male and female header receptacles), so that the KVM switch with a different number of ports (such as 4 ports, 8 ports or 16 ports) can be changed according to a user's requirement, and it is not necessary to remove the whole 4-in-1 structure and the fixed base for installing the KVM switch, and the KVM switch with a different number of ports can be latched directly with the fixed base.

### BACKGROUND OF THE INVENTION

1. Field of the Invention

The present invention relates to a bidirectional convertible KVM switch assembly structure and its KVM switch, and more particularly to a KVM switch connected at a rear end that adopts a design of latching/separating a fixed base to/from a standalone switch, and both of the control unit at the front end and the fixed base of the KVM switch at the rear end adopt a structural design of a V-shape moving arm and a pressing latch, such that when the KVM switch is installed, the latch of the base of the KVM switch is pressed according to the depth of a computer rack and then moved back and forth to a desired position for fixing the position of the KVM switch, so that the bidirectional convertible KVM switch of the invention can fit different sizes of cabinets.

2. Description of the Related Art

In a general four-in-one KVM switch (including a keyboard, a mouse, an LCD screen, and a KVM switch), a control unit (including the keyboard, mouse and LCD screen, also known as 3-in-1 control unit) at the front end can move back and forth along a glide track, and the KVM switch connected at the rear end is fixed to the glide track and cannot be moved back and forth. Therefore, it is necessary to change the size of the glide track to fit a different computer rack, if the KVM switch is mounted onto a computer rack (or cabinet) that comes with a different depth and thus both the assembling and material preparation become very inconvenient. Furthermore, it is necessary to redesign the existing standalone KVM switch for the expansion of an existing four-in-one KVM switch, and the number of ports of the present switches cannot be changed as needed anytime.

Therefore, a novel bidirectional convertible KVM switch assembly structure and its KVM switch are needed to overcome the foregoing shortcomings.

### SUMMARY OF THE INVENTION

The primary objective of the present invention is to provide a bidirectional convertible KVM switch assembly structure, and the KVM switch connected to a rear end adopts a design of latching/separating a fixed base to/from a standalone switch, and both of the control unit at the front end and the fixed base of the KVM switch at the rear end adopt a structural design of a V-shape moving arm and a pressing latch, such that when the KVM switch is installed, the latch of the base of the KVM switch is pressed according to the depth of a computer rack and then moved back and forth to a desired position for fixing the position of the KVM switch.

Another objective of the present invention is to provide a standalone KVM switch that comes with a detachable assembly and uses a base for accommodating and fixing the KVM switch, and the base and the KVM switch are latched by male and female connectors (male and female header receptacles), and thus the number of ports of the KVM switch (such as 4 ports, 8 ports, or 16 ports) can be changed anytime according to user's requirements, and it is not necessary to remove or change the whole 4-in-1 structure and fixed base, since the KVM switch with a different number of ports can be latched directly to the fixed base.

To achieve the foregoing objectives, the bidirectional convertible KVM switch assembly structure in accordance with the present invention comprises: a frame, a glide track disposed separately on both sides of the frame; a fixed based disposed at a distal end of the frame; a contractible mechanism transversally disposed in the frame and having both ends pressing at the internal sides of the frame and being capable of moving in the glide track, and a lateral side of the contractible mechanism is proximate to the fixed base, and another lateral side of the contractible mechanism is provided for holding a computer system; such that a KVM switch can be installed onto the fixed base, and a latching structure can be coupled to the contractible mechanism, so as to achieve the effect of moving the KVM switch bidirectionally along the glide track by using the contractible mechanism.

To achieve the foregoing objectives, the KVM switch of the invention comprises a casing, a printed circuit board, a plurality of switching circuits, a master control unit and at least one computer port, characterized in that a panel of the casing has a latch slot, and the printed circuit board has a plurality of connecting terminals disposed at the position of the latch slot, so that the KVM switch can be latched with other components by the connecting terminal.

Compared with the traditional technologies, the bidirectional convertible KVM switch of the invention has the features of a convenient assembling and a simplified assembling procedure to enhance production efficiency and lower costs.

To make it easier for our examiner to understand the objective of the invention, its structure, innovative features, and performance, we use a preferred embodiment together with the attached drawings for the detailed description of the invention as follows.

### BRIEF DESCRIPTION OF THE DRAWINGS

FIG. 1 is a schematic view of a bidirectional convertible KVM switch assembly structure according to a preferred embodiment of the present invention;

FIG. 2 is a schematic view of connecting a bidirectional convertible KVM switch assembly structure that connects a KVM switch according to the present invention;

FIGS. 3a and 3b are schematic views of connecting a bidirectional convertible KVM switch assembly structure with a KVM switch having many ports and a KVM switch having few ports respectively according to the present invention; and

FIG. 4 is a schematic view of a KVM switch of another preferred embodiment of the present invention.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

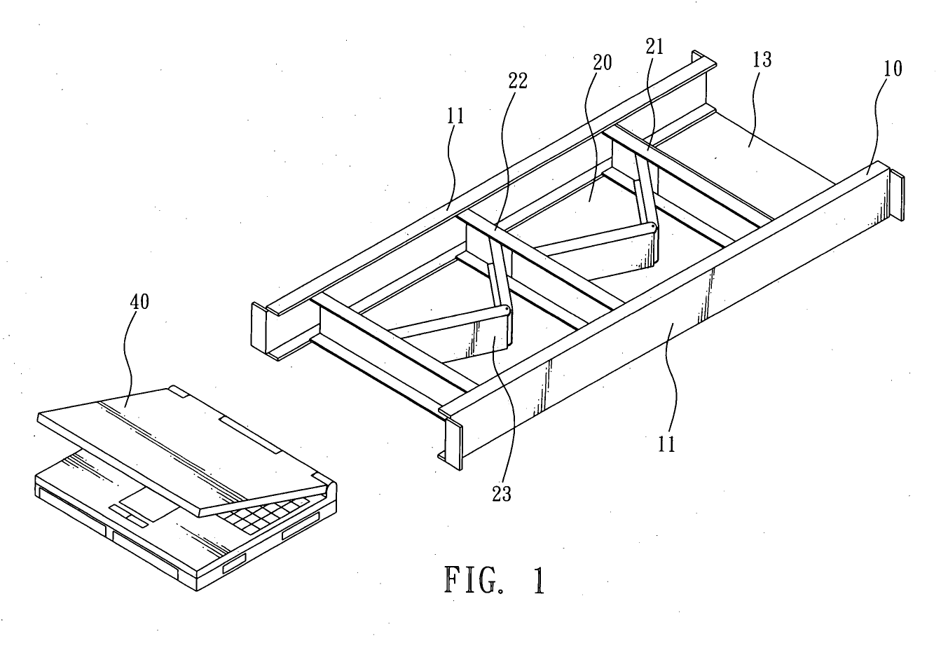

Referring to FIG. 1 for the schematic view of a bidirectional convertible KVM switch assembly structure of the present invention, the bidirectional convertible KVM switch assembly structure of the invention comprises a frame 10 and a contractible mechanism 20.

The frame 10 includes a glide track 11 disposed separately on both sides of the frame and a fixed base 13 disposed at a distal end of the frame 10. The frame can be installed in a computer rack (not shown in the figure).

The contractible mechanism 20 is transversally disposed in the frame 10, and both ends of the contractible mechanism 20 separately press against the internal sides of the frame 10 and can move along the glide track 11. A lateral side of the contractible mechanism 20 is proximate to the fixed base 13 and the other lateral side is provided for mounting a computer system 40 (including but not limited to a notebook computer).

The contractible mechanism 20 further comprises a first blocking wall 21, a second blocking wall 22 and a V-shape moving arm 23. The first blocking wall 21 is proximate to the fixed base 13 and has a latch structure disposed at an external side of the first blocking wall 21 for latching the KVM switch 30. The latch structure could be a protruding latch or a latch slot, and this embodiment adopts the protruding latch for illustration, but is not limited to such arrangement only. If the latch structure is a protruding latch 211, the KVM switch 30 has a latch slot 311 disposed at a position corresponding to the protruding latch 211 for latching the first blocking wall, and the protruding latch 211 is preferably a male connector or a male header receptacle. If the latch structure is a latch slot (not shown in the figure), the KVM switch 30 has a protruding latch (not shown in the figure) disposed at a position corresponding to the latch slot for latching the first blocking wall, and the latch slot is preferably a female connector or a female header receptacle.

The second blocking wall 22 is proximate to the computer system 40 for connecting and mounting the computer system 40, and the V-shape moving arm 23 is installed between the first blocking wall 21 and the second blocking wall 22, and an end of the V-shape moving arm is fixed to the first blocking wall 21 and another end of the V-shape moving arm is fixed to the second blocking wall 22, so that the first blocking wall 21 or the second blocking wall 22 can be pulled to draw the V-shape moving arm to move bidirectionally forward or backward.

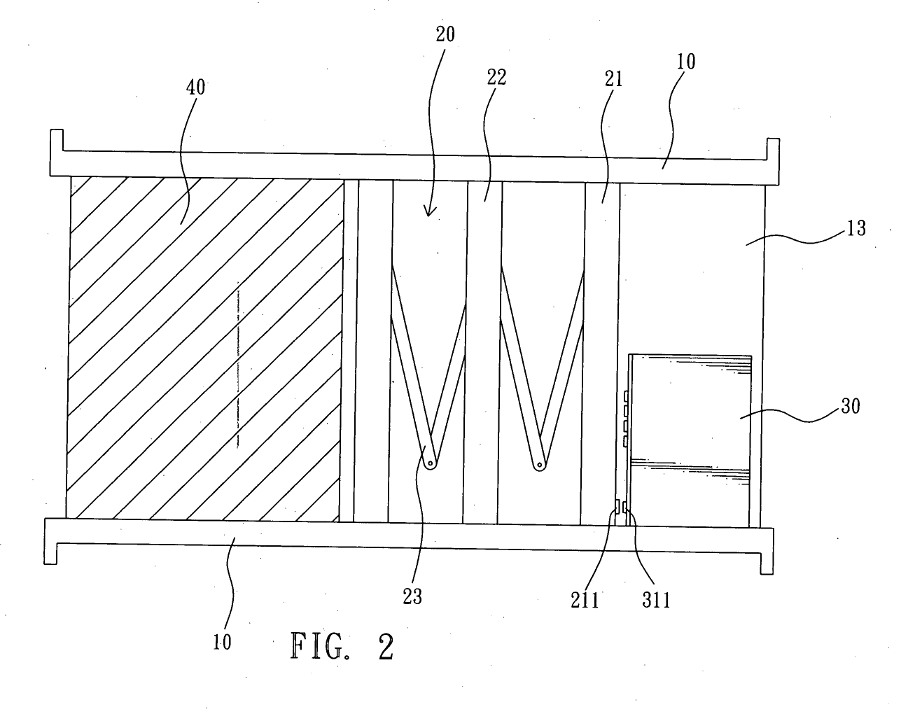

The frame 10 and contractible mechanism 20 are preferably made of a metal. The KVM switch 30 including but not limited to a four-in-one KVM switch including a keyboard, a mouse, a video display screen and a computer further comprises a latch slot 311 disposed at a position corresponding to the protruding latch 211 for latching the protruding latch 211 of the first blocking wall 21 (as shown in FIG. 2). Further, the KVM switch 30 further comprises a soft protective cap 33 plugged into the latch slot 311 for preventing the entrance of dust.

Further, the number of contractible mechanisms 20 can be changed as needed, and this embodiment adopts two contractible mechanisms 20 for the illustration, but the invention is not limited to such arrangement only.

Refer to FIG. 2 for the schematic view of connecting a bidirectional convertible KVM switch assembly structure and a KVM switch 30 according to the present invention. When the bidirectional convertible KVM switch assembly structure is connected to a KVM switch 30, the KVM switch 30 is placed on the fixed base 13, and the latch slot 311 of the KVM switch is latched to the protruding latch 211 of the first blocking wall 21 for mounting the KVM switch 30. To securely mount the KVM switch 30, a screw (not shown in the figure) can be used to secure the KVM switch 30 on the fixed base 13 or frame 10. However, it is not a key point of the present invention, and thus will not be described here. When the KVM switch assembly structure is used, the front end of the computer rack pulls the computer system 40, and the V-shape moving arm 23 is stretched forward to facilitate users to operate the computer system 40, or the rear end of the computer rack pulls the fixed base 13, and the V-shape moving arm 23 is stretched backward to facilitate users to maintain or replace the KVM switch 30. Therefore, the bidirectional convertible KVM switch assembly structure achieves the effect of bidirectionally moving the KVM switch forward or backward along the computer rack.

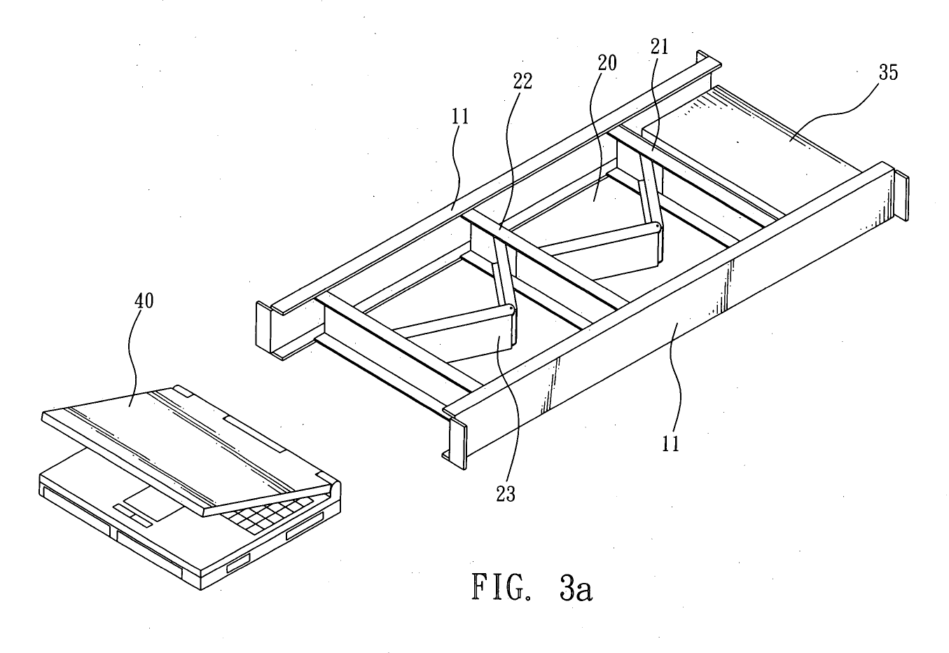

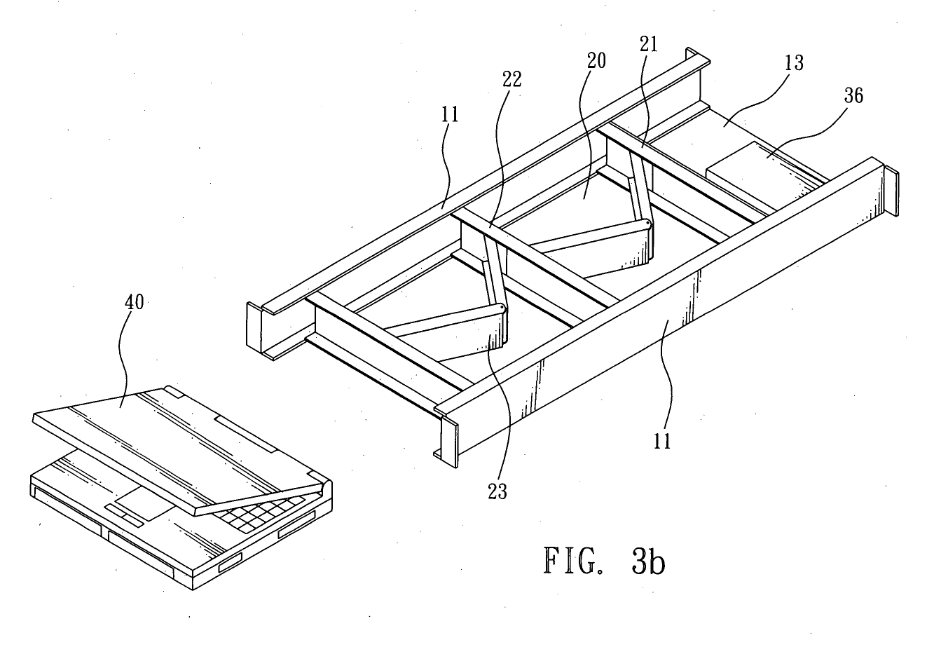

Refer to FIGS. 3a and 3b for the schematic views of connecting a bidirectional convertible KVM switch assembly structure with a KVM switch having many ports and a KVM switch having few ports respectively according to the present invention. In FIG. 3a, if the bidirectional convertible KVM switch assembly structure is connected to a KVM switch 35 having many ports, the KVM switch 35 having many ports is placed on the fixed base 13, and the latch slot 311 of the KVM switch 35 is latched to the protruding latch 211 of the first blocking wall 21, such that the KVM switch 35 can be mounted to complete the assembling. In FIG. 3b, if the bidirectional convertible KVM switch assembly structure is connected to a KVM switch 36 having few ports, the KVM switch 36 having few ports is placed on the fixed base 13 and latched with the protruding latch 211 of the first blocking wall 21 by the latch slot 311 of the KVM switch, so as to mount the KVM switch 36 to complete the assembling. Therefore, the bidirectional convertible KVM switch assembly structure of the invention can change the number of ports (such as 4 ports, 8 ports or 16 ports) for the KVM switch 30 according to the user's requirement, and it is not necessary to remove or change the whole assembly structure and the fixed base 13, and users only need to latch the KVM switch with a different number of ports 30 directly to the fixed base 13. Unlike the prior art that requires uses to remove or change the whole KVM switch assembly at the rear end, the bidirectional convertible KVM switch assembly structure of the invention can improve such shortcoming.

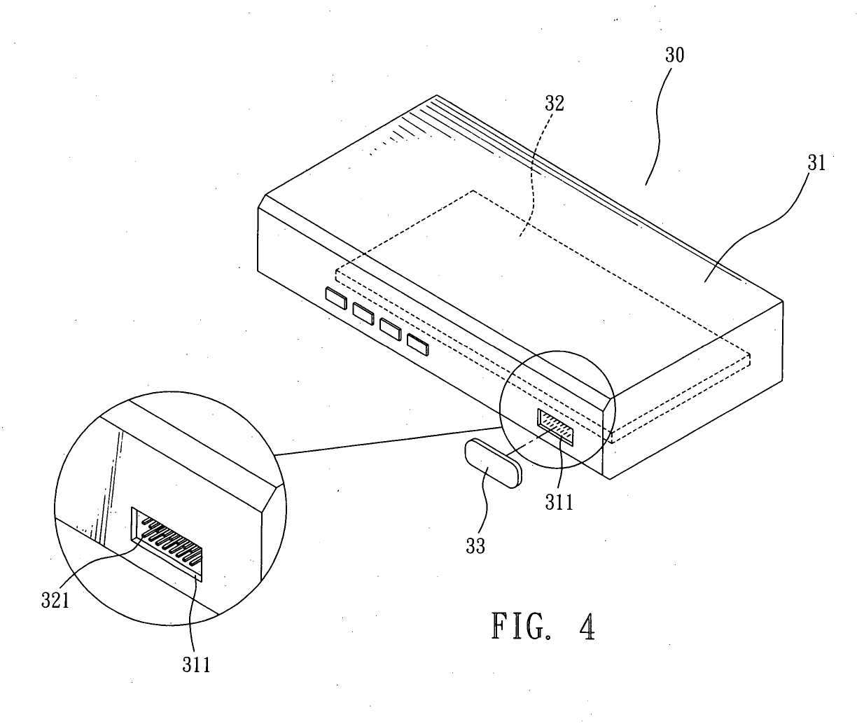

Referring to FIG. 4 for the schematic view of a KVM switch 30 according to another preferred embodiment of the present invention, the KVM switch 30 of the present invention is installed in a computer rack (not shown in the figure), and the computer rack includes the aforementioned frame 10 and contractible mechanism 20 (refer to the description above), and the KVM switch 30 comprises a casing 31,a printed circuit board 32, a plurality of switching circuits (not shown in the figure), a master control unit (not shown in the figure) and at least one computer port (not shown in the figure), characterized in that a panel of the casing 31 has a latch structure 311, and the printed circuit board 32 has a plurality of connecting terminals 321 disposed at the position of the latch structure 311, such that the connecting terminal 321 can latch the KVM switch 30 with the contractible mechanism 20. The KVM switch 30 further comprises a soft protective cap 33 plugged into the latch structure 311 or sheathed onto the external side of the latch structure 311 for preventing dust from entering into the KVM switch 30.

The latch structure 311 could be a protruding latch or a latch slot, and this embodiment adopts a latch slot for the illustration, but the invention is not limited to such arrangement only. If the latch structure is a latch slot 311 including but not limited to a female connector or a female header receptacle, and the KVM switch 30 is latched with the first blocking wall 21 through the latch slot 311. If the latch structure is a protruding latch (not shown in the figure) including but not limited to a male connector or a male header receptacle, the KVM switch 30 is latched to the first blocking wall 21 by the protruding latch.

In the bidirectional convertible KVM switch assembly structure of the invention, a base is used for accommodating and fixing the KVM switch, and the base and the KVM switch are latched with each other by male and female connectors (or male and female header receptacles) and thus the KVM switch with a different number of ports (such as 4 ports, 8 ports or 16 ports) can be changed anytime according to the user's requirement without the need of removing or changing the whole 4-in-1 structure and the fixed base. Users simply need to latch the KVM switch with a different number of ports directly into the fixed base, and thus the present invention definitely can overcome the shortcomings of the prior art bidirectional convertible KVM switch.

The present invention provides a feasible solution, and a patent application is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. A bidirectional convertible KVM switch assembly structure, comprising:
a frame, having a glide track disposed separately on both sides of said frame, and a fixed based, disposed at a distal end of said frame; and
a contractible mechanism, transversally disposed in said frame, and having both ends pressing on the internal sides of said frame, and said contractible mechanism being capable of moving in said glide track, and having a lateral side proximate to said fixed base and another lateral side for mounting a computer system;
thereby, a KVM switch can be disposed on said fixed base which is coupled to said contractible mechanism by a latch structure, and said KVM switch can be moved bidirectionally along the glide track by said contractible mechanism.

2. The bidirectional convertible KVM switch assembly structure of claim 1, wherein said frame is installed in a computer rack.

3. The bidirectional convertible KVM switch assembly structure of claim 1, wherein said contractible mechanism further comprises:
a first blocking wall, being proximate to said fixed base, and having a latch structure disposed at the external side of said first blocking wall for latching said KVM switch;
a second blocking wall, being proximate to said computer system; and
a V-shape moving arm, disposed between said first blocking wall and said second blocking wall, and having an end fixed to said first blocking wall and another end fixed to said second blocking wall, such that said first blocking wall or said second blocking wall is pulled for selectively stretching and contracting said V-shape moving arm bidirectionally.

4. The bidirectional convertible KVM switch assembly structure of claim 3, wherein said latch structure is a protruding latch, and said KVM switch has a latch slot disposed at a position corresponding to said protruding latch for latching said first blocking wall, and said latch slot is a female connector or a female header receptacle.

5. The bidirectional convertible KVM switch assembly structure of claim 3, wherein said latch structure is a latch slot, and said KVM switch has a protruding latch disposed at a position corresponding to said latch slot for latching said first blocking wall, and said protruding latch is a male connector or a male head receptacle.

6. The bidirectional convertible KVM switch assembly structure of claim 4, further comprising a soft protective cap plugged into said latch slot for preventing the entrance of dust.

7. The bidirectional convertible KVM switch assembly structure of claim 5, further comprising a soft protective cap sheathed onto the external side of said protruding latch for preventing the entrance of dust.

8. The bidirectional convertible KVM switch assembly structure of claim 1, wherein said KVM switch is a four-in-one KVM switch comprising a keyboard, a mouse, a video display screen and a computer.

9. A KVM switch, comprising a casing, a printed circuit board, plurality of switching circuits, a master control unit and at least one computer port, characterized in that a panel of said casing includes a latch structure, and said printed circuit board includes a plurality of connecting terminals disposed at the position of said latch structure, such that said KVM switch can be latched with other components by said connecting terminals.

10. The KVM switch of claim 9, wherein said KVM switch is a four-in-one KVM switch comprising a keyboard, a mouse, a video display screen and a computer.

11. The KVM switch of claim 9, wherein said latch structure is a protruding latch, and said protruding latch is a male connector or a male header receptacle.

12. The KVM switch of claim 10, wherein said latch structure is a latch slot, and said latch slot is a female connector or a female header receptacle.

13. The bidirectional convertible KVM switch assembly structure of claim 11, further comprising a soft protective cap sheathed onto the external side of said protruding latch for preventing the entrance of dust.

14. The bidirectional convertible KVM switch assembly structure of claim 12, further comprising a soft protective cap plugged into said latch slot for preventing the entrance of dust.
